(19) United States
(12) Patent Application Publication
(10) Pub. No.: US 2021/0401228 A1
(43) Pub. Date: Dec. 30, 2021

(54) Multi-Functional Beverage Container

(71) Applicant: Adam Craft, Scottsdale, AZ (US)

(72) Inventor: Adam Craft, Scottsdale, AZ (US)

(21) Appl. No.: 16/733,227

(22) Filed: Jan. 2, 2020

Related U.S. Application Data
(60) Provisional application No. 62/787,657, filed on Jan. 2, 2019.

(51) Int. Cl. A47J 41/00; A47J 19/02; A47G 19/22

(52) U.S. Cl. CPC A47J 41/0088; A47J 19/023; A47J 41/0044; A47J 41/0072; A47G 2019/225; A47G 19/2227; A47G 19/2288; A47J 2203/00; A47J 2202/00; A47J 41/0094

(57) ABSTRACT

The disclosure discloses a multi-functional beverage container that includes a multi-walled evacuated vessel body; an integrated juicing element to releasably nest within the multi-walled evacuated vessel body; a multi-walled vessel top that realeasably seals to the multi-walled vessel body and to receive the juicing element; and a multi-walled cap that realeasably seals to the multi-walled vessel top. The container may further comprise a planar straining element for straining purposes, various sealing gaskets, integrated volumetric measuring indicators, a fluid within the dual walls comprising a freezing point below at least zero degrees Celsius to maintain a chilled nature of a stored liquid within the container. The container may comprise thermo-chromatic paint to indicate a representative temperature has been achieved, external portions to comprise textured elements to facilitate grasping and twisting, and an internal sensor to wirelessly communicate a measured weight to a secondary wireless device.

### REFERENCE TO RELATED APPLICATION

This application claims the benefit of and priority to U.S. Provisional Patent Application No. 62/787,657 filed Jan. 2, 2019, the contents of which are incorporated herein by reference in their entirety.

### BACKGROUND

Beverage containers generally suffer from the detriment of allowing a contained cold beverage to quickly warm or a hot beverage to quickly cool, thereby detracting from the enjoyment of the contained beverage. Many beverage containers have been designed to overcome this detriment by comprising a dual walled and/or evacuated walled configuration, however, various portions of the container are not similarly constructed, such as the bottom of the container, a lid, cap, etc. Thus, while many containers may comprise a main container body to be dual-walled or evacuated, the other elements of the container are no so constructed, thereby leading to the initial detriment. Moreover, many users rely upon a number of ancillary items to construct a desired beverage, such as ice crushers, strainers, volumetric measuring devices, juicers, and the like.

What is missing in the prior art, and disclosed by this disclosure, is a beverage container, that comprises not only a multi-walled beverage body, but also comprises multiwalled elements, such as, evacuated bottoms, lids, caps, and the like to more beneficially maintain the desired temperature of the contained liquid and overcome the detriments of the prior art. Even more so, what is missing in the prior art is not only a beverage container that can in a greater fashion maintain the temperature of the contained liquid, but that also has integrated with it a number of the ancillary elements used to prepare beverages, such as, an ice crusher, juicer, strainer, volumetric measuring device, etc.

### FIELD OF THE INVENTION

The present disclosure is directed towards a multi-functional beverage container. More particularly, the present disclosure comprises a metallic, insulated container comprising various integrated elements, for example, strainers, juicers, volumetric measuring indicators, ice crusher, and other elements to facilitate storing, containing, transporting, and preparing various liquids.

### SUMMARY

Among various exemplary embodiments, a multi-functional beverage container comprises; a multi-walled vessel body, an integrated juicing element to releasably nest within the vessel body, a multi-walled vessel top that realeasably seals to the multi-walled vessel body and receives the juicing element, and a cap that realeasably seals to the multi-walled vessel top.

The multi-functional beverage container further comprises various elements to facilitate preparing various liquid beverages, such as cocktails, soft drinks, smoothies, protein shakes, sports aid drinks, etc. For example, the multi-functional beverage container may comprise some, none, or all of the following. The beverage container may comprise a planar straining element to nest between the multi-walled vessel top and the multi-walled cap for straining purposes, various sealing gaskets to seal between the multi-walled evacuated vessel body and the multi-walled vessel top, as well as a sealing cap gasket to seal between the multi-walled vessel top and the multi-walled cap. The multi-walled vessel top may comprise integrated volumetric measuring indicators to aid in measuring liquids. The multi-walled evacuated vessel body may comprise, between the dual walls, a fluid comprising a freezing point below at least zero degrees Celsius to facilitate maintaining a chilled nature of a stored liquid within the container. Some embodiments may comprise at least one element of the multi-function beverage container to comprise a thermo-chromatic paint to indicate a representative temperature has been achieved. Some embodiments may comprise an external portion of at least one of the multi-walled evacuated vessel body, the multi-walled vessel top, and the multi-walled cap to comprise textured elements to facilitate grasping and twisting the multi-walled evacuated vessel body, the multi-walled vessel top, and the multi-walled cap relative to one another. And an embodiment may comprise an internal sensor to wirelessly communicate a measured weight to a secondary wireless device.

### BRIEF DESCRIPTION OF THE DRAWINGS

A more complete understanding of a multi-functional beverage container may be derived by referring to the detailed description and claims when considered in connection with the following illustrative FIGS. In the following FIGS, like reference numbers refer to similar elements and steps throughout the FIGS.

FIG. 1 representatively illustrates an exploded view of a multi-functional beverage container;

FIG. 2 representatively illustrates a cross section view of the multi-functional beverage container;

FIG. 3 representatively illustrates an exploded view of a vessel top and a juicing element;

FIG. 4 representatively illustrates a perspective view depicting the juicing element nested within the vessel top;

FIG. 5 representatively illustrates a perspective view depicting the volumetric measuring indicators integrated within the vessel top;

FIG. 6 representatively illustrates a cross section of the vessel top depicting an integrated wireless device to communicate with a wireless device such as the smart phone further depicted;

FIG. 7 representatively illustrates an embodiment of a multi-walled beverage container;

FIG. 8 representatively illustrates another embodiment of a multi-walled beverage container; and

FIG. 9 representatively illustrates cross-sections of the vessel top.

Elements in the FIGS. are illustrated for simplicity and clarity and have not necessarily been rendered according to any particular configuration. For example, elements system components shown may be constructed and/or assembled concurrently or in different order or embodiments, and are illustrated in the FIGS. to help to improve understanding of exemplary embodiments of the multi-functional beverage container.

### DETAILED DESCRIPTION

A multi-functional beverage container may be described herein in terms of various functional components and such functional components may be realized by any number of hardware and software components to perform specified functions and achieve various results. For example, the multi-functional beverage container may employ various types of containers to contain liquids, solids, semi-solids and the like, which all may carry out a variety of functions. In addition, the multi-functional beverage container may be practiced in conjunction with any number of manners for operating as an article which a container may contain a liquid as well as provide elements to facilitate carrying out a variety of liquid preparation actions. And any multi-functional beverage containers described by the present disclosure are merely representative applications for the multi-functional beverage container. Further, the multi-functional beverage container may employ any number of conventional techniques for providing such a beverage container and incorporated elements and/or assembling it into a desired configuration to operate as a multi-functional beverage container by which the container may contain a liquid as well as comprise various elements to facilitate carrying out a variety of liquid preparation activities.

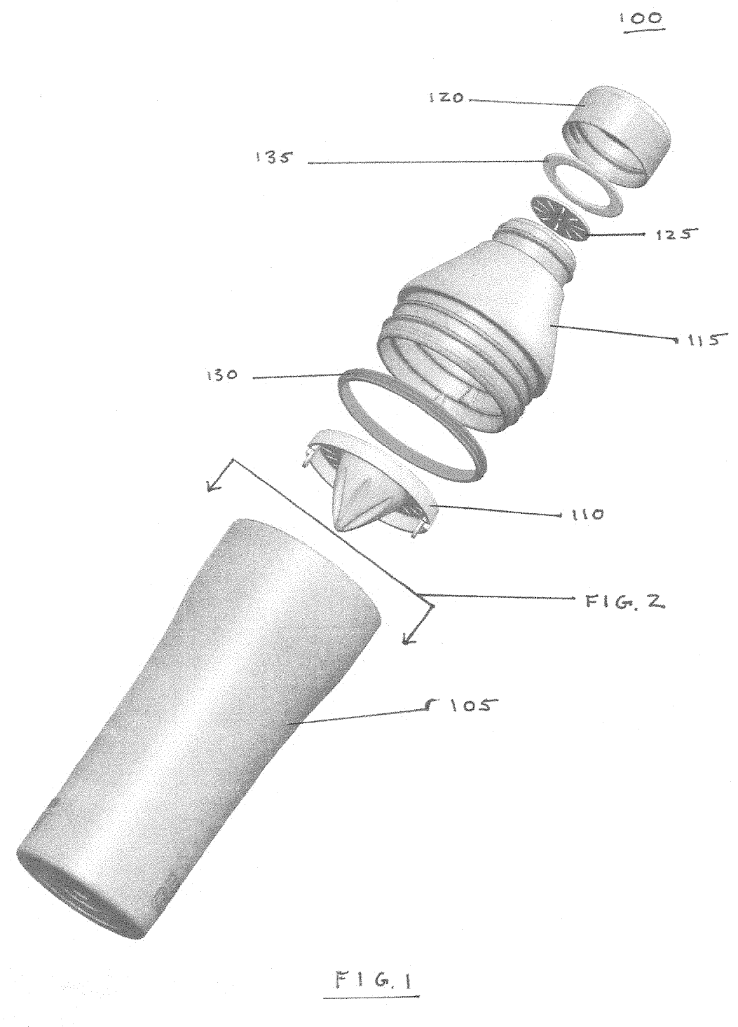

Various embodiments of the multi-functional beverage container may be applied to any item, object or person that may benefit from the container to contain a liquid as well as benefit from the various incorporated elements to facilitate carrying out a variety of liquid preparation activities. Referring now to the various FIGS., FIG. 1 depicts an exploded view of multi-functional beverage container 100, wherein multi-functional beverage container 100 comprises: a multi-walled evacuated vessel body 105; an integrated juicing element 110 to releasably nest within multi-walled evacuated vessel body 105; a multi-walled vessel top 115 that realeasably seals to multi-walled vessel body 105 and can receive juicing element 110; and a multi-walled cap 120 that realeasably seals to multi-walled vessel top 115.

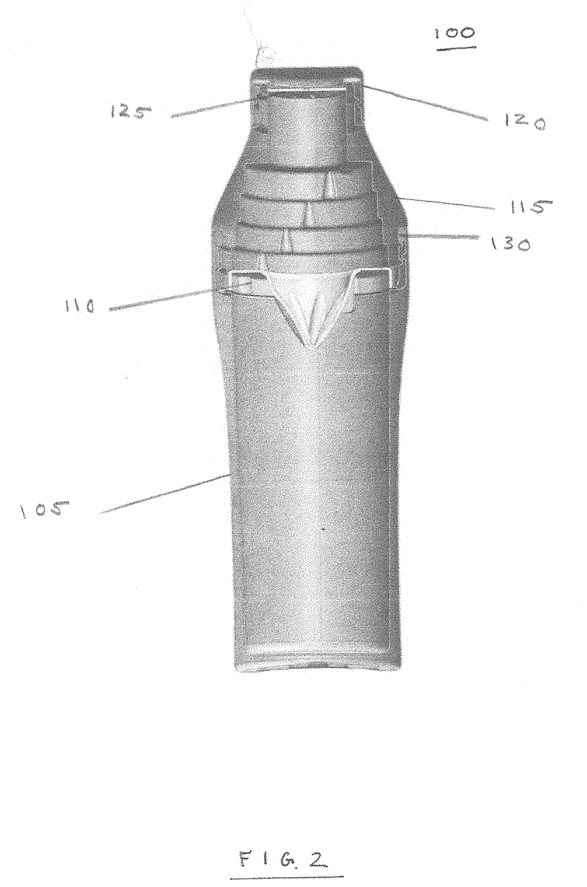

Multi-functional beverage container 100 further comprises various elements to facilitate preparing various liquid beverages, such as cocktails, soft drinks, smoothies, protein shakes, sports aid drinks, etc. For example, multi-functional beverage container may comprise some, none, or all of the following. Beverage container 100 may comprise a planar straining element 125 to nest between multi-walled vessel top 115 and multi-walled cap 120 for straining purposes. Beverage container 100 may further comprise various sealing gaskets, such as body gasket 130 to seal between multi-walled evacuated vessel body 105 and multi-walled vessel top 115; as well as a sealing cap gasket 135 to seal between multi-walled vessel top 115 and multi-walled cap 120. With reference to FIG. 2, beverage container 100 is depicted via a cross section of beverage container 100 and shown in an assembled condition.

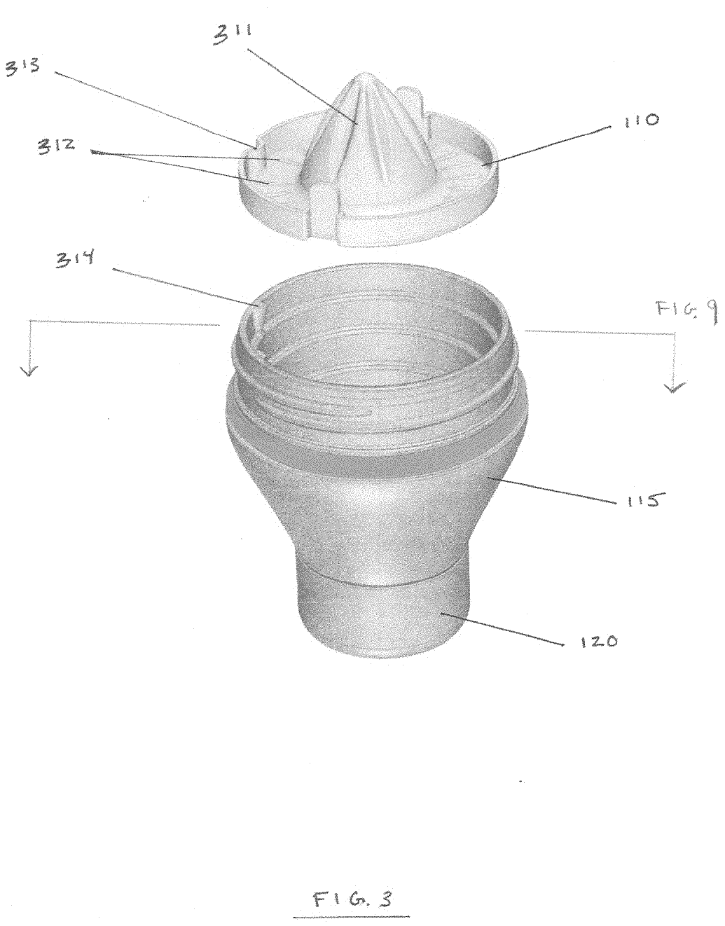

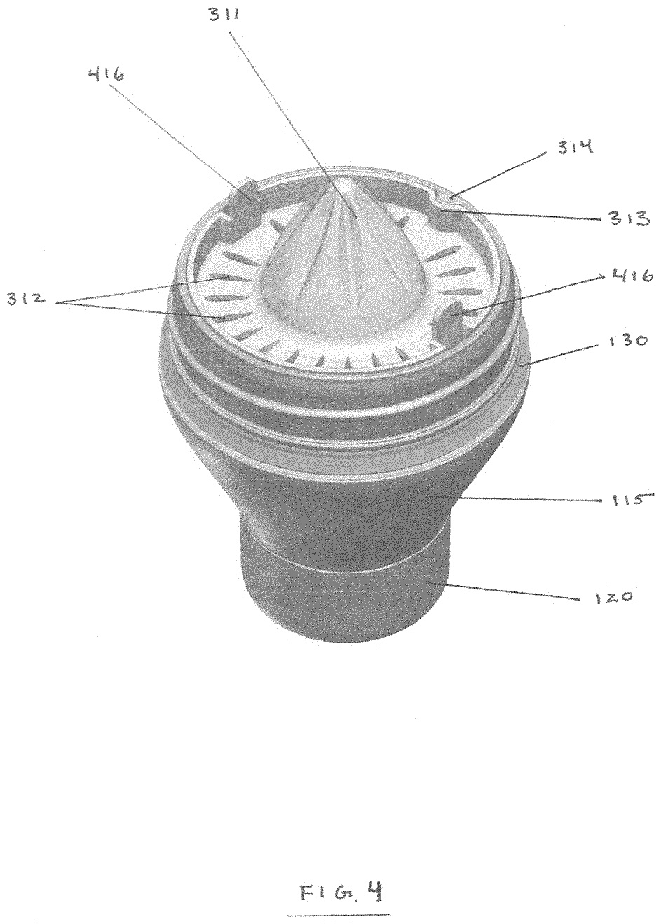

Turning now to FIG. 3, juicing element 110 and multi-walled vessel top 115 are shown. This representative embodiment depicts juicing element 110 comprising a juicing spire 311 that those skilled in the art will understand is used to juice a food item, such as fruit comprising, for example, oranges, grapefruits, lemons, limes, and the like. Juicing element 110 further comprises juicing ports 312 to facilitate extracted juices to flow through juicing element 110. Moreover, juicing element 110 comprises juice keys 313 that mate with juice tabs 314 integrated within multi-walled vessel top 115 to deter any torsional movement of juicing element 110 during a juicing action. With reference to FIG. 4, juicing element 110 is shown in the nested, fixed position within multi-walled vessel top 115. FIG. 4 further depicts juicing tabs 416 that facilitate removing juicing element 110 from its nested position within multi-walled vessel top 115 by a user.

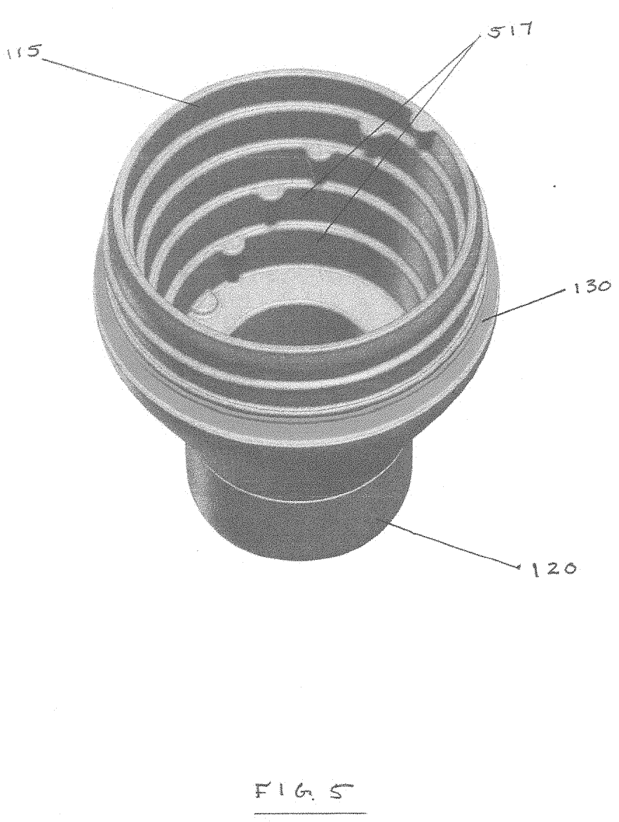

Turning now to FIG. 5, multi-walled vessel top 115 may comprise integrated volumetric measuring indicators 517 to aid in measuring liquids. As a user pours a liquid into multi-walled vessel top 115, the various graduated ridges 517 may indicate for a user that a particular volumetric amount has been achieved, for example, 1 ounce, 2 ounces, etc. This elemental feature aids in measuring for particular liquid recipes.

Among some representative embodiments, multi-walled evacuated vessel body 105 may comprise, between at least two of the multi-walls, a fluid comprising a freezing point below at least zero degrees Celsius to facilitate maintaining a chilled nature of a stored liquid within the container. Some embodiments may comprise at least one element of multi-function beverage container 100 to comprise a thermo-chromatic paint to indicate a representative temperature has been achieved. Although not depicted in the FIGS. some representative embodiments may comprise an external portion of at least one of multi-walled evacuated vessel body 105, multi-walled vessel top 115, and/or multi-walled cap 120 to comprise textured elements to facilitate grasping and twisting multi-walled evacuated vessel body 105, multi-walled vessel top 115, and/or multi-walled cap 120 relative to one another.

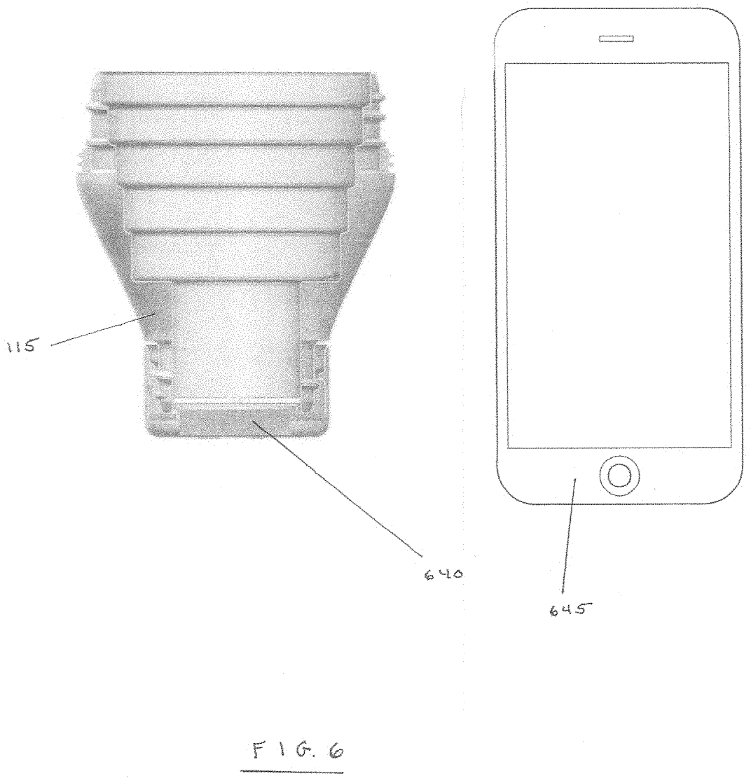

With reference to FIG. 6, a representative embodiment may comprise an internal sensor 640 within multi-walled vessel top 115 to wirelessly communicate a measured weight to a secondary wireless device, for example smart phone device 645.

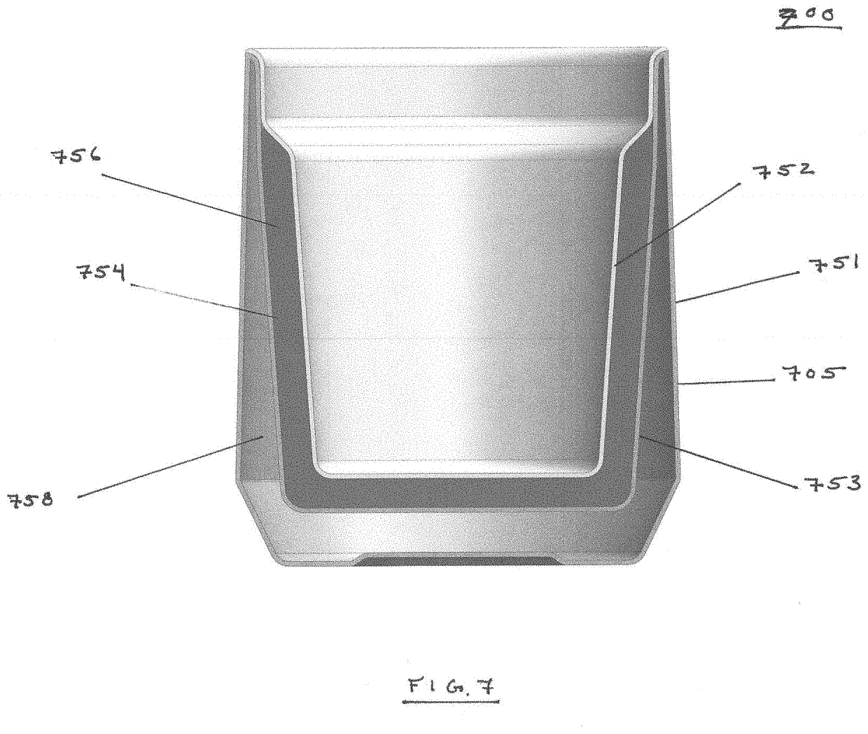

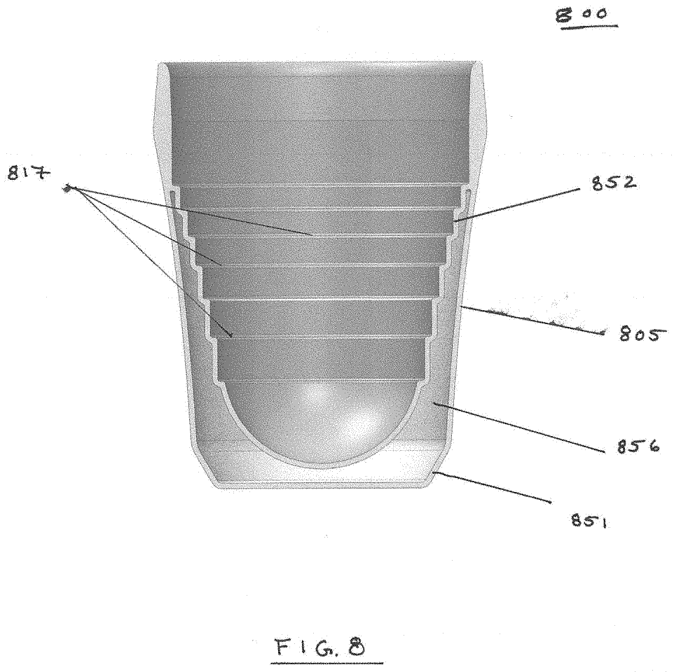

Turning now to FIGS. 7 and 8, FIGS. 7 and 8 depict embodiment of a multi-walled beverage container, but rather than comprising a number of function elements as disclosed with respect to container 100, the multi-walled beverage containers as depicted in FIGS. 7 and 8 are directed to beverage container used more so for consumption of a beverage. For example, multi-walled beverage container 700 comprises container body 705 comprising a tri-walled configuration comprising; an outer wall 751, an inner wall 752, and an intermediary wall 753. As can be seen, an inner area 756 created between inner wall 752 and intermediary wall 753 may be filled by a chilling material 754, as described earlier, that comprises a freezing temperature below 0 degrees Celsius to facilitate maintaining a contained beverage in a cold condition. Further as can be seen, container body 705 may also comprise an outer area 758 created between intermediary wall 753 and outer wall 751, which in this assembly comprises an evacuated area to facilitate mitigating transfer of heat from outside container 700 to inside the container 700, as well as to mitigate the transfer of heat from inside container 700 to outside container 700. It will be appreciated by those skilled in the art that while one area, such as area 756 of the tri-walled configuration of container 700 comprises chilling material 754 and the other area, such as area 758, of the tri-walled container 700 is evacuated, other embodiments may comprise alternate constructions. For example, both areas 756 and 758 may comprise chilling material, both areas may be evacuated, outer area 758 may comprise chilling material and inner area 756 may be evacuated rather than vice versa as shown, or that container 700 comprises additional areas created by additional walls, which may be similarly constructed to comprise chilling materials and/or be evacuated. It will also be appreciated by those skilled in the art that beverage container 100 may comprise the various multi-walled configurations, inner and outer areas, chilling material filled areas, evacuated areas, etc., as just disclosed with respect to container 700 and vice versa.

Turning now to FIG. 8, FIG. 8 discloses another embodiment of a multi-walled beverage container, a container 800 comprises container body 805 comprising, in this embodiment a dual-walled configuration comprising an outer wall 851 and an inner wall 852. As can be seen, an inner area 856 created between inner wall 852 and outer wall 851 may be evacuated as shown to deter the transfer of heat across area 856, and it may be filled by a chilling material, as described earlier with respect to container 700, that comprises a freezing temperature below 0 degrees Celsius to facilitate maintaining a contained beverage in a cold condition. Further as can be seen, container 800 may comprises integrated volumetric measuring indicators 817, similar to measuring indicators 517 disclosed earlier, to aid in measuring liquids. As a user pours a liquid into container body 805, the various graduated ridges 817 may indicate for a user that a particular volumetric amount has been achieved, for example, 1 ounce, 2 ounces, etc.

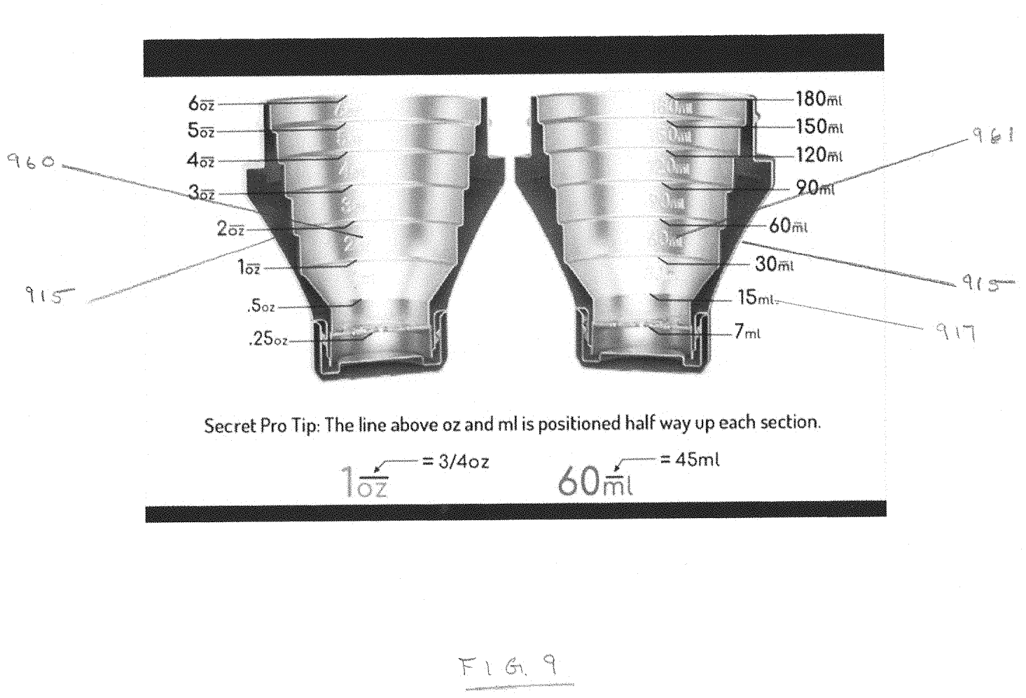

Turning now to FIGS. 9A and 9B, FIGS. 9A and 9B depict cross-sections of representative embodiments of a multi-walled vessel top 915 comprises integrated volumetric measuring indicators 917 to aid in measuring liquids, similar to volumetric measuring indicators 517 as shown and described in FIG. 5., i.e., as a user pours a liquid into multi-walled vessel top 915, the various graduated ridges 917 may indicate for a user that a particular volumetric amount has been achieved, for example, 1 ounce, 2 ounces, 30 ml, 60 ml, etc. However, in this embodiment, vessel top 915 further comprises indicator half lines 960 and 961 respectively above the “oz” or “ml” indicators to symbolically indicate a halfway point between the identified markings. This allows a user to measure a volumetric portion between the markings shown, but without having to have excessive markings inscribed upon the vessel top. For example, indicator half line 960 indicates the halfway point between 1 oz and 2 oz, i.e., 1.5 oz. Similarly, indicator half line 961 indicates the halfway point between 30 ml and 60 ml, i.e., 45 ml. It will be appreciated by those skilled in the art that other symbolic markings may be further integrated, inscribed, and the like upon multi-walled vessel top 915

In the foregoing specification, the multi-functional beverage container has been described with reference to embodiments. It will be appreciated by those skilled in the art that the some, all, or none of the various elements and/or constrictions of an embodiment may be realized by some, all, or none of any other embodiments. Various modifications and changes may be made, however, without departing from the scope of the multi-functional beverage container as set forth in the claims. The specification and FIGS. are illustrative, rather than restrictive, and modifications are intended to be included within the scope of the multi-functional beverage container. Accordingly, the scope of the multi-functional beverage container should be determined by the claims and their legal equivalents rather than by merely the representative embodiments described.

For example, the components and/or elements recited in any physical embodiment claims may be assembled or otherwise operationally constructed in a variety of permutations and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

As used herein, the terms “comprise”, “comprises”, “comprising”, “having”, “including”, “includes” “is” or any variation thereof, are intended to reference a non-exclusive inclusion, such that a system, process, method, article, composition or apparatus that comprises a list of elements does not include only those elements recited, but may also include other elements not expressly listed or inherent to such system, process, method, article, composition or apparatus. Other combinations and/or modifications of the above-described structures, arrangements, applications, proportions, elements, materials or components used in the practice of the multi-functional beverage container, in addition to those not specifically recited, may be varied or otherwise particularly adapted to specific environments, manufacturing specifications, design parameters or other operating requirements without departing from the general principles of the same.

1. A multi-functional beverage container comprises:
a multi-walled evacuated vessel body;
an integrated juicing element that releasably nests within the multi-walled evacuated vessel body;
a multi-walled vessel top that realeasably seals to the multi-walled vessel body, and receives the juicing element; and
a multi-walled cap that realeasably seals to the multi-walled vessel top.

2. The container of claim 1, further comprising a planar straining element that nests between the multi-walled vessel top and the multi-walled cap.

3. The container of claim 2, further comprising a sealing body gasket to seal between the multi-walled evacuated vessel body and the multi-walled vessel top.

4. The container of claim 3, further comprising a sealing cap gasket to seal between the multi-walled vessel top and the multi-walled cap.

5. The container of claim 4, wherein the multi-walled vessel top comprises integrated volumetric measuring indicators.

6. The container of claim 5, wherein the multi-walled evacuated vessel body further comprises between at least two of the multi-walls a fluid comprising a freezing point below at least zero degrees Celsius.

7. The container of claim 6, wherein at least one element of the multi-function beverage container comprises a thermo-chromatic paint to indicate a representative temperature has been achieved.

8. The container of claim 7, wherein an external portion of at least one of the multi-walled evacuated vessel body, the multi-walled vessel top, and the multi-walled cap comprises textured elements to facilitate grasping and twisting the multi-walled evacuated vessel body, the multi-walled vessel top, and the multi-walled cap relative to one another.

9. The container of claim 8, wherein the multi-walled cap comprises an internal sensor to wirelessly communicate a measured weight to a secondary wireless device.

10. A multi-functional beverage container comprises:
a multi-walled evacuated vessel body;
an integrated juicing element that releasably nests within the multi-walled evacuated vessel body;
a multi-walled vessel top that realeasably seals to the multi-walled vessel body, and receives the juicing element;
a multi-walled cap that realeasably seals to the multi-walled vessel; and
integrated volumetric measuring indicators inscribed upon the multi-walled vessel top.

11. The container of claim 10, further comprising a planar straining element that nests between the multi-walled vessel top and the multi-walled cap.

12. The container of claim 11, further comprising a sealing body gasket to seal between the multi-walled evacuated vessel body and the multi-walled vessel top.

13. The container of claim 12, further comprising a sealing cap gasket to seal between the multi-walled vessel top and the multi-walled cap.

14. The container of claim 13, wherein the multi-walled evacuated vessel body further comprises between at least two of the multi-walls a fluid comprising a freezing point below at least zero degrees Celsius.

15. The container of claim 14, wherein at least one element of the multi-function beverage container comprises a thermo-chromatic paint to indicate a representative temperature has been achieved.

16. The container of claim 15, wherein an external portion of at least one of the multi-walled evacuated vessel body, the multi-walled vessel top, and the multi-walled cap comprises textured elements to facilitate grasping and twisting the multi-walled evacuated vessel body, the multi-walled vessel top, and the multi-walled cap relative to one another.

17. The container of claim 16, wherein the multi-walled cap comprises an internal sensor to wirelessly communicate a measured weight to a secondary wireless device.

18. A multi-functional beverage container comprises:
a multi-walled evacuated vessel body;
an integrated juicing element that releasably nests within the multi-walled evacuated vessel body;
a multi-walled vessel top that realeasably seals to the multi-walled vessel body, and receives the juicing element;
a multi-walled cap that realeasably seals to the multi-walled vessel; and integrated volumetric measuring indicators inscribed upon the multi-walled vessel top, wherein the volumetric measuring indicators comprise indicator half lines to symbolically indicate a halfway volumetric point between the volumetric measuring indicators inscribed.

19. The container of claim 18, further comprising a planar straining element that nests between the multi-walled vessel top and the multi-walled cap.

20. The container of claim 19, wherein the multi-walled evacuated vessel body further comprises between at least two of the multi-walls a fluid comprising a freezing point below at least zero degrees Celsius.
